(19) United States
(12) Patent Application Publication
(10) Pub. No.: US 2026/0120493 A1
(43) Pub. Date: Apr. 30, 2026

(54) STRING EXTRACTION FROM IMAGES AND RELATED COMPUTING SYSTEMS AND METHODS

(71) Applicant: CDK GLOBAL, LLC, Austin, TX (US)

(72) Inventor: Anup KUMAR, Portland, OR (US)

(21) Appl. No.: 18/932,557

(22) Filed: Oct. 30, 2024

(51) Int. Cl. G06V 30/19; G06V 30/24

(52) U.S. Cl. CPC G06V 30/19093; G06V 30/248

(57) ABSTRACT

Methods of extracting text strings from target images and related computing systems and computer-readable media are disclosed. A method of extracting text strings from a target image includes identifying template spatial coordinates from template image data corresponding to a template image. The template spatial coordinates define a boundary around a template text string in the template image. The method includes identifying, in a target image, target spatial coordinates defining boundaries around one or more identified regions including target text strings. The method includes identifying overlapping regions of the one or more identified regions that overlap the boundary defined by the template spatial coordinates and identifying one of the target text strings to be a match for the template text string based, at least in part, on a nearest neighbors analysis comparing the template text string to the target text strings corresponding to the overlapping regions.

### TECHNICAL FIELD

This disclosure relates generally to string extraction from images and related computing systems and methods.

### BACKGROUND

Optical character recognition (OCR) is a commonly used technique of extracting text from digital images. OCR techniques may include processing a digital image to isolate text and recognize individual characters or words.

### BRIEF SUMMARY

In some embodiments, a computing system includes one or more processors and one or more data storage devices configured to store template coordinate data indicating template spatial coordinates defining a boundary around a template text string in a template image of a template document. The one or more data storage devices are also configured to store template text data indicating the template text string. The one or more data storage devices are further configured to store computer-readable instructions configured to instruct the one or more processors to identify, in a target image of a target document corresponding to the template document, target spatial coordinates defining boundaries around one or more overlapping regions including target text strings. The one or more overlapping regions overlap the boundary around the template text string. The computer-readable instructions are further configured to instruct the one or more processors to identify one of the target text strings of the one or more overlapping regions to be a match for the template text string based, at least in part, on a nearest neighbors analysis comparing the target text strings of those of the identified regions that overlap the boundary defined by the template spatial coordinates to the template text string.

In some embodiments, a method of extracting text strings from a target image includes identifying template spatial coordinates from template image data corresponding to a template image of a template document. The template spatial coordinates define a boundary around a template text string in the template image. The method also includes identifying, in a target image of a target document corresponding to the template document, target spatial coordinates defining boundaries around one or more identified regions including target text strings. The method further includes identifying overlapping regions of the one or more identified regions that overlap the boundary defined by the template spatial coordinates and identifying one of the target text strings to be a match for the template text string based, at least in part, on a nearest neighbors analysis comparing the template text string to the target text strings corresponding to the overlapping regions.

In some embodiments, one or more non-transitory computer-readable media include computer-readable instructions stored thereon. The computer-readable instructions are configured to instruct one or more processors to identify, in a target image of a target document, target spatial coordinates defining boundaries around one or more identified regions including target text strings. The computer-readable instructions are also configured to instruct the one or more processors to identify those of the identified regions that overlap a boundary defined by template spatial coordinates of a template region including a template text string within a template image of a template document corresponding to the target document. The computer-readable instructions are further configured to instruct the one or more processors to adjust the template spatial coordinates to increase an area of the template region responsive to a determination that one or more relevant overlapping regions are yet to be identified and rank overlapping regions based, at least in part, on distances of their target spatial coordinates from the template spatial coordinates. The computer-readable instructions are also configured to instruct the one or more processors to identify one of the target text strings to be a match for the template text string based, at least in part, on a nearest neighbors analysis comparing the template text string to the target text strings corresponding to the overlapping regions.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a flowchart illustrating a method of extracting text strings from a target image, according to some embodiments;

FIG. 2A is an example of a template image of a template document that may be used in the method of FIG. 1;

FIG. 2B illustrates the example template image of FIG. 2A with boundaries around template text strings entered into blanks of the template document of FIG. 2A;

FIG. 3A is an example of a target image of a target document that may be used in the method of FIG. 1;

FIG. 3B illustrates the example target image of FIG. 3A with boundaries around identified regions including target text strings entered into blanks of the target document of FIG. 3A;

FIG. 3C is the example target image of FIG. 3A illustrating template boundary from FIG. 2B and target boundaries from FIG. 3B;

FIG. 3D is the example target image of FIG. 3C illustrating template boundary adjusted to increase an area of the template region defined by the template spatial coordinates;

FIG. 4 is a block diagram of a computing system, according to some embodiments; and

FIG. 5 is a block diagram of circuitry that, in some embodiments, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments enabled herein may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. In some instances, similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed embodiments. The use of the terms “exemplary,” “by example,” and “for example” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawings could be arranged and designed in a wide variety of different configurations. Thus, the following description of various embodiments is not intended to limit the scope of the present disclosure, but is merely representative of various embodiments. While the various aspects of the embodiments may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general-purpose processor, a special-purpose processor, a digital signal processor (DSP), an integrated circuit (IC), an application-specific integrated circuit (ASIC), a field programmable gate array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, the term “string,” in the context of computing, refers to a data type including an array of characters (e.g., letters, numbers, symbols, etc.) arranged in a sequence. A string may be used to represent text. In computing, strings may be used to store and manipulate text data.

Extracting text strings from image files may be useful in various contexts. For example, various industries use fillable forms to obtain information. As a specific example, fillable forms may be used in the context of vehicle dealerships, which use fillable forms for financing applications, sales contracts, service contracts, lease agreements, and the like. Blanks, input boxes, signature lines, and other similar regions on a fillable form may be filled with electronically typed text, handwritten text, or combinations of electronically typed text and handwritten text.

Extracting text from completed fillable forms may pose various challenges. For example, methods of capturing and uploading images of completed fillable forms may vary from person to person, which may result in differences in border and scaling characteristics from one completed fillable form to another. Also, different people may add text to a fillable form at slightly different positions within a given blank or text reception block. As a result, it may be difficult to anticipate an exact location and/or size of text that should be extracted from within a digital image of a completed fillable form. Also, image quality may vary greatly depending on whether a digital image of a completed fillable form was captured using a smartphone camera, a dedicated document scanning device, or some other image capture device. As a result, lighting characteristics, clarity, resolution, and sharpness of lines may vary, and may sometimes be of low enough quality that OCR techniques struggle to identify characters within a digital image.

Embodiments disclosed herein relate to deterministic string extraction from images. In some embodiments, a computing system may employ a combination of artificial intelligence (AI) or optical character recognition (OCR), growing polygon-based extraction, and deterministic pattern-matching using a nearest neighbor algorithm to extract textual strings from images. Embodiments disclosed herein may improve reliability and/or accuracy in string extraction for various applications including text string extraction from completed fillable forms pictured in digital images.

In some embodiments, regions of a target image (e.g., a completed fillable form) including text (e.g., electronically generated text, handwritten text) may be identified and a subset of the identified regions that overlap a template text region for a particular template text string of a template text image may be ranked based on their degrees of overlap with the template text region. A nearest neighbors algorithm may be used to compare extracted text values from the list of the ranked regions of the target image to identify a determined match of one of the extracted text values with the template text string. In this way, reliable and accurate text string extraction may be performed within a reasonable constraint.

In the context of text classification, a nearest neighbors algorithm may be used to classify text data (e.g., strings identified in an image of a document) into predefined classes based on their similarity to other labeled text data. In some embodiments, raw text from a text string may be converted into a numerical format (also known as “vectorization”) using one or more of various techniques. By way of non-limiting examples, text may be converted into numerical format using bag-of-words (BoW) (e.g., representing text as a frequency count of words, ignoring grammar and order), term frequency-inverse document frequency (TF-IDF) (e.g., adjusting word frequencies based on how common they are across text strings, giving more weight to informative words), word embeddings (e.g., Word2Vec, GloVe) (e.g., mapping words into dense vector representations that capture semantic meaning), and/or sentence embeddings (e.g., BERT, Sentence Transformers) (e.g., providing vector representations for entire sentences or text strings, capturing contextual meaning).

With the text strings converted into numerical format, a distance metric may be used to measure the similarity between the text strings. By way of non-limiting examples, the similarity may be measured using one or more of cosine similarity, Euclidean distance, or Jaccard similarity. A classification process (e.g., K-nearest neighbors, voting scheme, regression variation, etc.) may then be used to identify matching text strings.

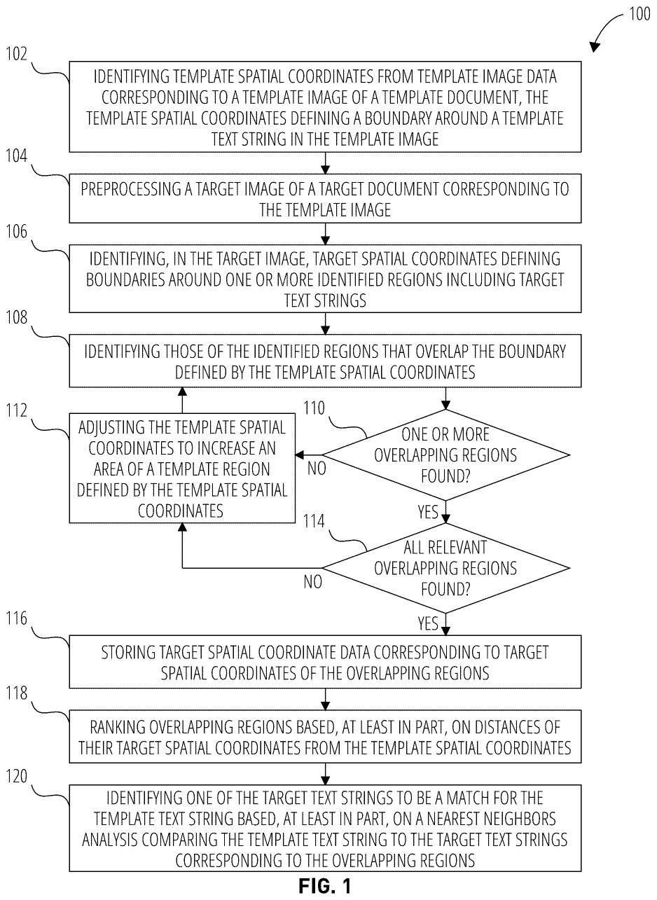

FIG. 1 is a flowchart illustrating a method 100 of extracting text strings from a target image, according to some embodiments.

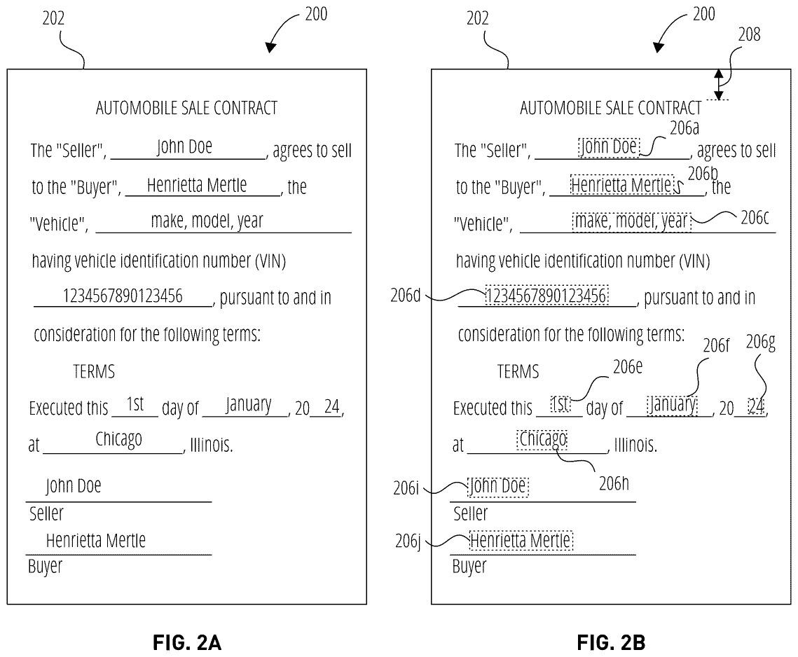

FIG. 2A is an example of a template image 200 of a template document 202 that may be used in the method 100 of FIG. 1. The template document 202 of FIG. 2A is an automobile sale contract, which is an example of a fillable form. In other words, the template image 200 includes several blanks filled in using template text. For example, the template image 200 includes two blanks for the “Seller,” which are filled in with “John Doe” in the template image 200. The template image 200 also includes two blanks for the “Buyer,” which are filled in with “Henrietta Mertle” in the template image 200. The template image 200 further includes a blank for “make, model, year”; a blank for vehicle identification number (VIN) (filled with “1234567890123456” in FIG. 2A); blanks for day, month, and year of a date the sale is being executed (filled with “1st,” “January,” and “24,” respectively); and a blank for a city within the state of Illinois where the sale is being executed (filled with “Chicago”).

Other fillable forms that could be used in the context of a vehicle dealership include other sales forms (e.g., a bill of sale, an odometer disclosure statement, a vehicle trade-in form), financing and leasing forms (e.g., a credit application, a retail installment sales contract (RISC), a lease agreement, a co-signer guarantor form, etc.), service department forms (e.g., a service request, a repair order, a service history form, a warranty claim form, etc.), insurance and warranty forms (e.g., a gap insurance application, an extended warranty/service contract agreement, a proof of insurance form, etc.), customer feedback and privacy forms (e.g., a customer satisfaction survey, a privacy notice, etc.), and/or other miscellaneous forms (e.g., a deposit receipt form, a test drive agreement, etc.). It should be noted that embodiments disclosed herein are also useful in settings different from vehicle dealerships. For example, any setting where text is automatically extracted from digital documents may benefit from embodiments disclosed herein.

Referring to FIG. 1 and FIG. 2A together, at operation 102, the method 100 includes identifying template spatial coordinates from template image data corresponding to a template image (e.g., the template image 200) of a template document (e.g., the template document 202), the template spatial coordinates defining a boundary around a template text string (e.g., around the text strings filled into the blanks of the template document 202) in the template image (e.g., the template image 200).

FIG. 2B illustrates the example template image 200 of FIG. 2A with boundaries 206a-206j around template text strings entered into blanks of the template document 202 of FIG. 2A. For example, boundary 206a is around template text string “John Doe” in the top “Seller” blank, boundary 206b is around template text string “Henrietta Mertle” in the top “Buyer” blank, boundary 206c is around template text string “make, model, year” in the “Vehicle” blank, boundary 206d is around template text string “1234567890123456” in the “VIN” blank, boundary 206e is around template text string “1st” in the day blank, boundary 206f is around template text string “January” in the month blank, boundary 206g is around template text string “24” in the year blank, boundary 206h is around template text string “Chicago” in the city blank, boundary 206i is around template text string “John Doe” in the bottom “Seller” blank, and boundary 206j is around template text string “Henrietta Mertle” in the bottom “Buyer” blank.

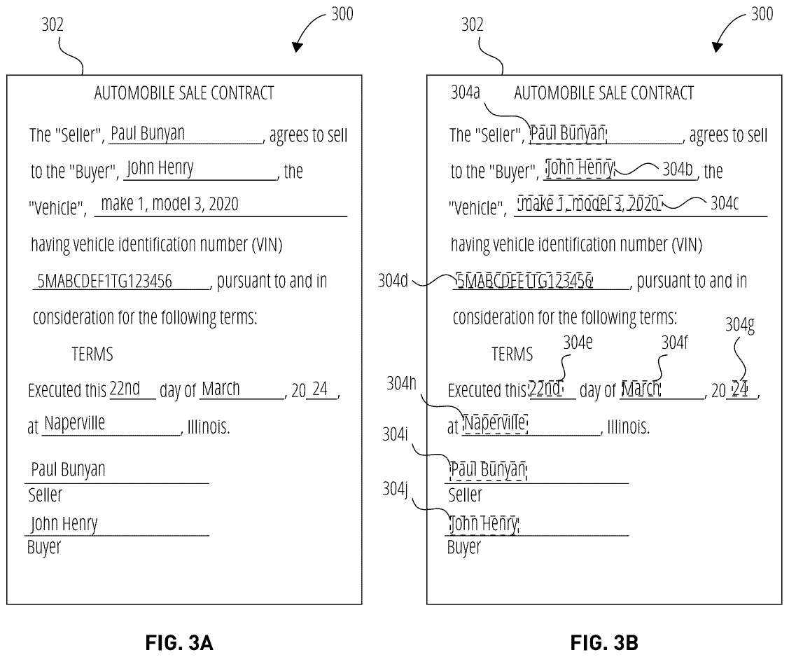

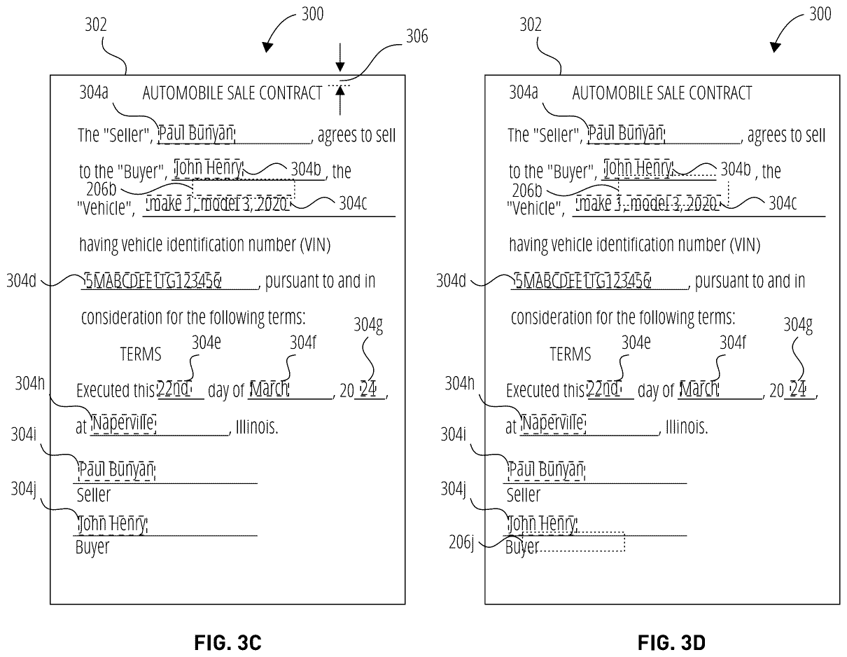

Referring to FIG. 1 and FIG. 2B together, identifying template spatial coordinates from the template image data (operation 102) may include initial identification. For example, specific regions (e.g., polygons or other shapes) containing template text strings within the template image 200 may be identified (e.g., the regions defined by the boundaries 206a-206j) and extracted (e.g., the template text strings may be extracted). In the example illustrated in FIG. 2B, the polygons defined by the boundaries 206a-206j are illustrated as rectangles for the sake of simplicity. In practice, the boundaries 206a-206j may define any type of polygon around the text strings of the template document 202 (e.g., to conform to the shape of the text in the text strings). These identified and extracted regions may serve as templates for subsequent value extraction, which may involve pinpointing the template spatial coordinates of these regions with precision to ensure that the template spatial coordinates are well-defined for use in the method 100. In other words, where template spatial coordinates for boundaries around regions including template text strings in a template document (e.g., the template document 202), target regions defined by similar spatial coordinates in a target document (e.g., target document 302 of FIG. 3A) may be sought out in the target document and target text strings within the target regions may be extracted.

In some embodiments, the template text strings may be automatically detected in the template image. By way of non-limiting example, a software program may be used to automatically detect text strings that are located within blanks (e.g., over bottom lines or within boxes defining blanks) of the template document. Also by way of non-limiting example, a graphical user interface may be presented to a user on an electronic display to enable a user to manually select strings of template text from the template document. In some embodiments, user intervention and interaction through a graphical user interface may assure that all of template text strings within blanks of the template document have been identified so that later in target documents, the target text strings within these blanks may be searched for and identified.

The graphical user interface may enable the user to indicate a significance or meaning of the template text strings within each identified template region. For example, the user may indicate that specific ones of the identified template text strings are directed to a seller name; a buyer name; a vehicle make, model, and year; a VIN; a day, month, year of a vehicle sale; a city where the vehicle sale was executed; and signatures for the seller and the buyer.

FIG. 3A is an example of a target image 300 of a target document 302 that may be used in the method 100 of FIG. 1. The target document 302 is the same document (the automobile sale contract) of the template document 202 of FIG. 2A and FIG. 2B, except the blanks of the target document 302 are filled with target text corresponding to a current vehicle sale. For example, the “Seller” blanks have been filled with “Paul Bunyan,” the “Buyer” blanks have been filled with “John Henry,” the “make, model, and year” blank has been filled with “make 1, model 3, 2020,” and the VIN blank has been filled with “5MABCDEF1TG123456.” Also, the day, month, year, and city blanks have been filled with “22nd,” “march,” “24,” and “Naperville,” respectively.

Referring to FIG. 1 and FIG. 3A together, at operation 104, the method 100 includes preprocessing a target image of a target document corresponding to the template image. Preprocessing the target image (e.g., the target image 300) may include enhancing the target image to generate a preprocessed target image. For example, preprocessing techniques may be applied to improve image quality and readability. By way of non-limiting examples, one or more of noise reduction, contrast adjustment, layout detection, or combinations thereof may be applied. Noise reduction may include using techniques such as Gaussian blur or median filtering to reduce noise and enhance image clarity. Contrast adjustment may include implementing techniques such as histogram equalization or contrast stretching to enhance the contrast between text and background. Layout detection may include detecting and segmenting different layout components within the image. By way of non-limiting example, text, blocks, headings, and paragraphs may be detected and segmented to facilitate accurate extraction of relevant regions (e.g., polygons or other shapes).

At operation 106, the method 100 includes identifying, in the target image (e.g., the target image 300), target spatial coordinates defining boundaries around one or more identified regions (e.g., polygons or other shapes) including target text strings.

FIG. 3B illustrates the example target image 300 of FIG. 3A with boundaries 304a-304j around identified regions including target text strings entered into blanks of the target document 302 of FIG. 3A. For example, boundary 304a is around template text string “Paul Bunyan” in the top “Seller” blank, boundary 304b is around template text string “John Henry” in the top “Buyer” blank, boundary 304c is around template text string “make 1, model 3, 2020” in the “Vehicle” blank, boundary 304d is around template text string “1234567890123456” in the “VIN” blank, boundary 304e is around template text string “22nd” in the day blank, boundary 304f is around template text string “March” in the month blank, boundary 304g is around template text string “24” in the year blank, boundary 304h is around template text string “Naperville” in the city blank, boundary 304i is around template text string “Paul Bunyan” in the bottom “Seller” blank, and boundary 304j is around template text string “John Henry” in the bottom “Buyer” blank.

Referring to FIG. 1 and FIG. 3B together, in some embodiments, identifying target spatial coordinates defining boundaries (e.g., boundaries 304a-304j) around one or more identified regions at operation 106 may include region identification and polygon conversion. Region identification may include using artificial intelligence (AI) algorithms (e.g., machine learning models trained for image analysis) to identify and extract regions of interest from the preprocessed target image. Polygon conversion may include converting the identified regions into multiple polygons (e.g., each defined by one of the boundaries 304a-304j). Each polygon may be defined by a set of coordinates. Each polygon may be associated with extracted text values that represent a textual content contained within the respective identified region.

The regions identified within the target image 300 may be candidates for correlation with any given one of the template regions defined by the boundaries 206a-206j of the template image 200 identified at operation 102. Whereas at operation 102, manual intervention (e.g., via a graphical user interface) may have been used (e.g., via a graphical user interface) to identify template text strings of interest and indicate meanings of the template text strings, at operation 106, the regions defined by the boundaries 206a-206j may have been identified free of manual intervention as being candidates for being correlated with any one of the template regions identified at operation 102. Any one of the target regions defined by the boundaries 304a-304j may be a candidate for containing the same type of information as any one of the template regions defined by the boundaries 206a-206j. The remaining operations of the method 100 (e.g., operation 108 through operation 120 may be used to automatically (e.g., without human intervention) identify one of the target text strings in one of the identified regions defined by the boundaries 304a-304j to be a match with a particular one of the template regions defined by the boundaries 206a-206j in the template image 200.

As a specific, non-limiting example, for the template region defined by boundary 206b (including the template text string for the buyer name), one of the target text strings in an identified region defined by one of the boundaries 304a-304j may be automatically matched to the template region defined by boundary 206b.

FIG. 3C is the example target image 300 of FIG. 3A illustrating template boundary 206b from FIG. 2B and target boundaries 304a-304j from FIG. 3B. The boundary 206b is at the same template spatial coordinates as in the template image 200 of FIG. 2B. As may be observed in FIG. 3C, the boundary 206b does not align with the “Buyer” blank in the target document 302 as it did in the template document 202. This may be the result of a different process used to capture the target image 300 as that used for capturing the template image 200. For example, a distance 306 between the title “AUTOMOBILE SALE CONTRACT” and the top of the target image 300 is smaller than a distance 208 between the title and the top of the template image 200 in FIG. 2B, which may indicate that the text in the target image 300 is spatially offset relative to the text in the template image 200. Also, the template text in the blanks of the target image 300 is added to a left-hand side of each of the blanks, in contrast to the template text in the blanks of the template image 200, which is more horizontally centered in the blanks. This example illustrates that there is no guarantee that simply capturing text in a same spatial location in a target image as corresponding text in a template image will result in capturing the desired text.

At operation 108, the method 100 includes identifying those of the identified regions (e.g., the regions defined by the boundaries 304a-304j) that overlap the boundary defined by the template spatial coordinates (e.g., boundary 206b). In some embodiments, identifying those of the identified regions that overlap the boundary defined by the template spatial coordinates may include performing an initial region lookup and handling overlaps. Initial region lookup may include performing a lookup operation to locate regions within the preprocessed target image that correspond to the template spatial coordinates. This lookup may determine whether the regions identified at operation 106 overlap with the template spatial coordinates. In the example of FIG. 3C, only the boundary 304c overlaps the template boundary 206b.

Handling overlaps may address scenarios where there are overlapping regions found and where there is not overlap between regions found at decision 110. Where there are overlapping regions, the identified regions may have varying degrees of overlap with the template boundary defined by the template coordinates (e.g., boundary 206b). In this case, the overlapping regions (e.g., all overlapping regions) are considered in the analysis. If there is no overlap between the template coordinates and any region identified at operation 106, the template spatial coordinates may be expanded to cover a broader area at operation 112. The greater the area defined by the template spatial coordinates expands, the more of the regions identified at operation 106 will overlap the area defined by the template spatial coordinates.

In the example illustrated in FIG. 3C, since the boundary 206b is overlapped by a boundary 304b, the method 100 proceeds to decision 114, which includes determining whether all relevant overlapping regions have been found. If not, then the method 100 may proceed to operation 112 to adjust the template spatial coordinates to increase the area of the template region defined by the template spatial coordinates. In some embodiments, determining whether all relevant overlapping regions have been found may include comparing the target text strings of the overlapping regions to the template text string of the overlapped template region. In the example of FIG. 3C, the target text associated with the overlapping region defined by boundary 304c is “make 1, model 3, 2020,” and the template text associated with the overlapped template region defined by boundary 206b is the name “Henrietta Mertle.” A comparison between the target text string “make 1, model 3, 2020” and the template text string “Henrietta Mertle” may reveal that the strings include information of different types (e.g., a make, model, and year versus a person's name). As a result, in this example, at decision 114, it may be determined that not all relevant overlapping regions have been found since the only overlapping target region includes a different type of text than the overlapped template region. As a result, the method 100 may proceed to operation 112.

At operation 112, the method 100 includes adjusting the template spatial coordinates to increase an area of a template region defined by the template spatial coordinates. This expanded template region may then be used to perform operation 108 again to identify overlapping regions. Operation 112 and operation 108 may be repeated iteratively (e.g., via decision 110 and/or decision 114), resulting in expansion of the template region and identification of overlapping regions, until all relevant overlapping regions are identified and stored. This repeating and storing may be continued until an end of a page or image is reached, ensuring that all potential regions of the image are considered. If all the relevant overlapping regions are found at decision 114, the method 100 may proceed to operation 116.

FIG. 3D is the example target image 300 of FIG. 3C illustrating template boundary 206b adjusted to increase an area of the template region defined by the template spatial coordinates (e.g., at operation 112). Referring to FIG. 1 and FIG. 3D together, returning to operation 108 from operation 112, two target regions defined by boundary 304b and boundary 304c are identified as overlapping the expanded template boundary 206b. As a result, the target areas defined by boundary 304b and boundary 304c are identified as overlapping the template region defined by the boundary 206b, which in turn is defined by the template spatial coordinates. At decision 110, it is determined that two overlapping target regions have been found, so the method 100 proceeds to decision 114. At decision 114, it is determined that all the overlapping regions have been found. For example, it may be determined that overlapping target region defined by boundary 304b, which includes the target text string “John Henry,” includes a name, as does the template region defined by the overlapped boundary 206b. As a result, all the relevant overlapping regions may be found and the method 100 proceeds to operation 116.

At operation 116, the method 100 includes storing target spatial coordinate data corresponding to target spatial coordinates of the overlapping regions identified at operation 108. In the example of FIG. 3D, the target spatial coordinates defining the boundary 304b and the boundary 304c, which defined regions determined to overlap the template boundary 206b, may be stored. At operation 118, the method 100 includes ranking the overlapping regions based, at least in part, on distances of their target spatial coordinates from the template spatial coordinates. By way of non-limiting example, once the overlapping regions (e.g., polygons or other shapes) are identified and stored, the overlapping regions may be ranked based on a distance of their target spatial coordinates relative to the template spatial coordinates. This ranking may help in prioritizing the relevance of each polygon in relation to the template. In the example of FIG. 3D, the target region defined by boundary 304c may be ranked ahead of the target region defined by boundary 304d due to a higher degree of overlap of the target region defined by boundary 304c as compared to a lower degree of overlap of the target region defined by boundary 304b.

At operation 120, the method 100 includes identifying one of the target text strings to be a match for the template text string based, at least in part, on a nearest neighbors analysis comparing the template text string to the target text strings corresponding to the overlapping regions. Accordingly, identifying the one of the target text strings to be a match for the template text string may including matching text of the ranked regions (e.g., polygons or other shapes) to template text string. In some embodiments, matching the target text strings of the ranked regions (e.g., polygons or other shapes) to the template values may include traversing the ranked list of regions and comparing the extracted text values to the template value. A nearest neighbor analysis may be used to determine the closest match by evaluating the similarity between the target text strings and the template text string. Matching the target text strings of the ranked regions to the template text string may also include identifying the most accurate match based on the nearest neighbor comparison, ensuring that the matched target text string aligns closely with the expected template text string.

In the example of FIG. 3D, the nearest neighbors analysis may identify the target text string “John Henry” associated with the target region defined by boundary 304b as a closer match to the template text string “Henrietta Mertle” from the template region defined by boundary 206b than the target text “make 1, model 3, 2020” from the target region defined by the boundary 304c. As a result, the target text string “John Henry” may be associated with the buyer name for the automobile sale contract of the target document 302.

Operation 104 through operation 120 of the method 100 have above been discussed for the template region defined by template boundary 206b. Operation 104 through operation 120 may be performed for each of the others of the boundaries 206a-boundary 206j to extract the text for each of the blanks in the target document 302.

As discussed above, user intervention (e.g., via a graphical user interface) may be used to identify and provide significance for template text strings in a template image (e.g., at operation 102). The method 100 enables automatic detection of corresponding target text strings in a subsequent target template image without intervention from a user. Accordingly, once a template image of a template document is processed (e.g., at operation 102), the remainder of the method 100 may be used to reliably and accurately extract target text strings within a reasonable constraint. Compared to conventional text recognition methods (e.g., OCR alone), the method 100 may provide for a more accurate text identification and extraction, especially where fillable forms are used and the location of text strings within an image is not conclusively known beforehand.

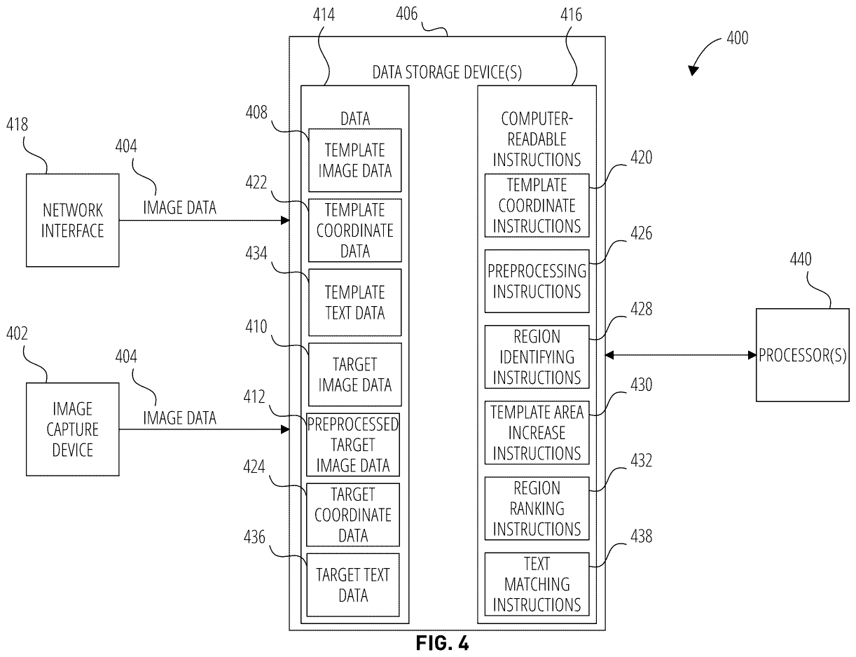

FIG. 4 is a block diagram of a computing system 400, according to some embodiments. The computing system 400 is an example of a system that may be used to perform the method 100 of FIG. 1. The computing system 400 includes a network interface 418, an image capture device 402, one or more data storage devices 406, and one or more processors 440. Image data 404 may be provided to the data storage devices 406 by the network interface 418, the image capture device 402, or both. For example, the image data 404 may be transmitted to the computing system 400 via one or more networks (e.g., the Internet, a personal area network such as Bluetooth, etc.) and the network interface 418 (e.g., a wired and/or a wireless network interface) from a device remote to the computing system 400. Also by way of non-limiting example, the image capture device 402 may include a camera or a document scanner configured to provide the image data 404 to the computing system 400. The data storage devices 406 may store the image data 404 as template image data 408 or target image data 410. By way of non-limiting example, when a vehicle sale is completed, a user may provide image data 404 of a vehicle sale contract via the network interface 418 or the image capture device 402, and the data storage devices 406 may store the image data 404 as target image data 410.

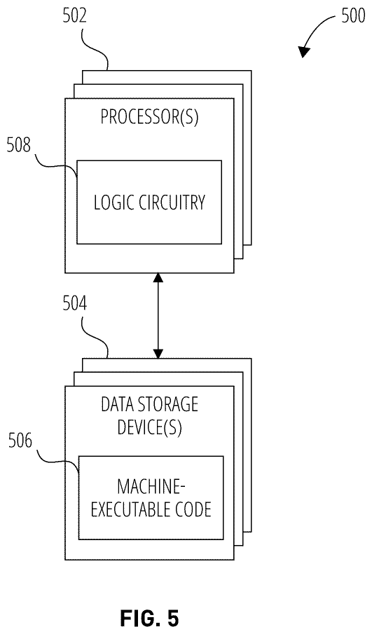

The one or more data storage devices 406 include one or more volatile data storage devices (e.g., random access memory (RAM), cache memory, registers, etc.), one or more non-volatile data storage devices (e.g., a hard disk drive, a solid-state drive, optical storage, etc.), or combinations thereof. By way of non-limiting example, the one or more data storage devices 406 may be implemented as the storage 504 discussed with reference to FIG. 5. The one or more data storage devices 406 are configured to store data 414 and computer-readable instructions 416 for embodiments of the disclosure. For example, the data 414 may include template image data 408 corresponding to one or more template images (e.g., the template image 200 of FIG. 2A), template coordinate data 422 indicating template spatial coordinates for boundaries (e.g., the boundaries 206a-206j of FIG. 2B) defining template regions including template text strings, and template text data 434 indicating the template text strings. The data 414 may also include target image data 410 corresponding to one or more target images (e.g., the target image 300 of FIG. 3A through FIG. 3D), preprocessed target image data 412 (e.g., preprocessed at operation 104 of FIG. 1), target coordinate data 424 indicating target spatial coordinates for boundaries (e.g., the boundaries 304a-304j of FIG. 3B through FIG. 3D) defining target regions including target text strings, and target text data 436 indicating the target text strings.

The computer-readable instructions 416 are configured to instruct the one or more processors 440 to perform various operations of the disclosure. For example, the computer-readable instructions 416 include template coordinate instructions 420 configured to perform operation 102 of FIG. 1. Also, the computer-readable instructions 416 include preprocessing instructions 426 configure to perform operation 104 of FIG. 1. The computer-readable instructions 416 may also include region identifying instructions 428 configured to perform operation 106 and operation 108 of FIG. 1. The computer-readable instructions 416 further include template area increase instructions 430 configured to perform decision 110, decision 114, operation 112, and operation 116 of FIG. 1. In addition, the computer-readable instructions 416 include region ranking instructions 432 configured to perform operation 118 of FIG. 1. The computer-readable instructions 416 may also include text matching instructions 438 configured to perform operation 120 of FIG. 1.

The one or more processors 440 may include one or more programmable devices configured to execute the computer-readable instructions 416. By way of non-limiting examples, the one or more processors 440 may include one or more central processing units (CPUs), one or more digital signal processors, one or more microcontrollers, one or more field programmable gate arrays (FPGAs), one or more application-specific integrated circuits (ASICs), other processors, or combinations thereof. Also by way of non-limiting example, the one or more processors 440 may be implemented as the processors 502 discussed with reference to FIG. 5.

In some embodiments, the one or more data storage devices 406 are configured to store template coordinate data 422 indicating template spatial coordinates defining a boundary around a template text string in a template image of a template document. The template text data 434 indicates the template text string. The computer-readable instructions 416 are configured to instruct the one or more processors 440 to identify, in a target image of a target document corresponding to the template document, target spatial coordinates defining boundaries around one or more identified regions including target text strings based at least in part on the template coordinate data 422. The computer-readable instructions 416 are also configured to instruct the one or more processors 440 to identify one of the target text strings of the one or more identified regions to be a match for the template text string based, at least in part, on a nearest neighbors analysis comparing the target text strings of those of the identified regions that overlap the boundary defined by the template spatial coordinates to the template text string.

In some embodiments, the computing system 400 may be executed by a single computer (e.g., a desktop computer, a server computer, a laptop computer, a tablet computer, a smartphone device, a point-of-sale device, etc.). In some embodiments, the computing system 400 may be distributed among multiple computer devices (e.g., between a user device and a remote server). By way of non-limiting example, the computing system 400 may be implemented to perform the method 100 as a web application. In such embodiments, the computing system 400 may be distributed across an application server and a user device executing a web browser, which in turn executes the web application. Portions of the data 414 and the computer-readable instructions 416 may be stored and/or executed at the application server and/or at the user device.

It will be appreciated by those of ordinary skill in the art that functional elements of embodiments disclosed herein (e.g., functions, operations, acts, processes, and/or methods) may be implemented in any suitable hardware, software, firmware, or combinations thereof. FIG. 5 illustrates non-limiting examples of implementations of functional elements disclosed herein.

In some embodiments, some or all portions of the functional elements disclosed herein may be performed by hardware specially configured for carrying out the functional elements.

FIG. 5 is a block diagram of circuitry 500 that, in some embodiments, may be used to implement various functions, operations, acts, processes, and/or methods disclosed herein. The circuitry 500 includes one or more processors 502 (sometimes referred to herein as “processors 502”) operably coupled to one or more data storage devices (sometimes referred to herein as “storage 504”). The storage 504 includes machine-executable code 506 stored thereon and the processors 502 include logic circuitry 508. The machine-executable code 506 includes information describing functional elements that may be implemented by (e.g., performed by) the logic circuitry 508. The logic circuitry 508 is adapted to implement (e.g., perform) the functional elements described by the machine-executable code 506. The circuitry 500, when executing the functional elements described by the machine-executable code 506, should be considered as special-purpose hardware configured for carrying out functional elements disclosed herein. In some embodiments the processors 502 may be configured to perform the functional elements described by the machine-executable code 506 sequentially, concurrently (e.g., on one or more different hardware platforms), or in one or more parallel process streams.

When implemented by logic circuitry 508 of the processors 502, the machine-executable code 506 is configured to adapt the processors 502 to perform operations of embodiments disclosed herein. For example, the machine-executable code 506 may be configured to adapt the processors 502 to perform at least a portion or a totality of the method 100 of FIG. 1. As another example, the machine-executable code 506 may be configured to adapt the processors 502 to perform at least a portion or a totality of the operations discussed for the computer-readable instructions 416 of FIG. 4. As a specific, non-limiting example, the machine-executable code 506 may be configured to adapt the processors 502 to identify, in a target image of a target document, target spatial coordinates defining boundaries around one or more identified regions including target text strings; identify those of the identified regions that overlap a boundary defined by template spatial coordinates of a template region including a template text string within a template image of a template document corresponding to the target document; adjust the template spatial coordinates to increase an area of the template region responsive to a determination that one or more relevant overlapping regions are yet to be identified; rank overlapping regions based, at least in part, on distances of their target spatial coordinates from the template spatial coordinates; and identify one of the target text strings to be a match for the template text string based, at least in part, on a nearest neighbors analysis comparing the template text string to the target text strings corresponding to the overlapping regions. As another specific, non-limiting example, the machine-executable code 506 may be configured to adapt the processors 502 to identify, in a target image of a target document corresponding to the template document, target spatial coordinates defining boundaries around one or more identified regions including target text strings based at least in part on the template coordinate information; and identify one of the target text strings of the one or more identified regions to be a match for the template text string based, at least in part, on a nearest neighbors analysis comparing the target text strings of those of the identified regions that overlap the boundary defined by the template spatial coordinates to the template text string.

The processors 502 may include a general-purpose processor, a special-purpose processor, a central processing unit (CPU), a microcontroller, a programmable logic controller (PLC), a digital signal processor (DSP), an application-specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is configured to execute functional elements corresponding to the machine-executable code 506 (e.g., software code, firmware code, hardware descriptions) related to embodiments of the present disclosure. It is noted that a general-purpose processor (may also be referred to herein as a host processor or simply a host) may be a microprocessor, but in the alternative, the processors 502 may include any conventional processor, controller, microcontroller, or state machine. The processors 502 may also be implemented as a combination of computing devices, such as a combination of a DSP and a microprocessor, a plurality of microprocessors, one or more microprocessors in conjunction with a DSP core, or any other such configuration.

In some embodiments the storage 504 includes volatile data storage (e.g., random access memory (RAM)), non-volatile data storage (e.g., flash memory, a hard disc drive, a solid-state drive, erasable programmable read-only memory (EPROM), etc.). In some embodiments the processors 502 and the storage 504 may be implemented into a single device (e.g., a semiconductor device product, a system on chip (SOC), etc.). In some embodiments the processors 502 and the storage 504 may be implemented into separate devices.

In some embodiments the machine-executable code 506 may include computer-readable instructions (e.g., software code, firmware code). By way of non-limiting example, the computer-readable instructions may be stored by the storage 504, accessed directly by the processors 502, and executed by the processors 502 using at least the logic circuitry 508. Also by way of non-limiting example, the computer-readable instructions may be stored on the storage 504, transferred to a memory device (not shown) for execution, and executed by the processors 502 using at least the logic circuitry 508. Accordingly, in some embodiments the logic circuitry 508 includes electrically configurable logic circuitry 508.

In some embodiments the machine-executable code 506 may describe hardware (e.g., circuitry) to be implemented in the logic circuitry 508 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG™, SYSTEMVERILOG™, or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 508 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some embodiments the machine-executable code 506 may include an HDL, an RTL, a GL description, a mask-level description, other hardware description, or any combination thereof.

In embodiments where the machine-executable code 506 includes a hardware description (at any level of abstraction), a system (not shown, but including the storage 504) may be configured to implement the hardware description described by the machine-executable code 506. By way of non-limiting example, the processors 502 may include a programmable logic device (e.g., an FPGA or a PLC) and the logic circuitry 508 may be electrically controlled to implement circuitry corresponding to the hardware description into the logic circuitry 508. Also by way of non-limiting example, the logic circuitry 508 may include hard-wired logic manufactured by a manufacturing system (not shown, but including the storage 504) according to the hardware description of the machine-executable code 506.

Regardless of whether the machine-executable code 506 includes computer-readable instructions or a hardware description, the logic circuitry 508 is adapted to perform the functional elements described by the machine-executable code 506 when implementing the functional elements of the machine-executable code 506. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations configured to perform the actions of the module or component and/or software objects or software routines that may be stored on and/or executed by general-purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general-purpose hardware), specific hardware implementations or a combination of software and specific hardware implementations are also possible and contemplated.

As used in the present disclosure, the term “combination” with reference to a plurality of elements may include a combination of all the elements or any of various different sub-combinations of some of the elements. For example, the phrase “A, B, C, D, or combinations thereof” may refer to any one of A, B, C, or D; the combination of each of A, B, C, and D; and any sub-combination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated embodiments, those of ordinary skill in the art will recognize and appreciate that the present invention is not so limited. Rather, many additions, deletions, and modifications to the illustrated and described embodiments may be made without departing from the scope of the invention as hereinafter claimed along with their legal equivalents. In addition, features from one embodiment may be combined with features of another embodiment while still being encompassed within the scope of the invention as contemplated by the inventor.

What is claimed is:

1. A computing system, comprising:
one or more processors; and
one or more data storage devices configured to store:
template coordinate data indicating template spatial coordinates defining a boundary around a template text string in a template image of a template document;
template text data indicating the template text string; and
computer-readable instructions configured to instruct the one or more processors to:
identify, in a target image of a target document corresponding to the template document, target spatial coordinates defining boundaries around one or more overlapping regions including target text strings, the one or more overlapping regions overlapping the boundary around the template text string; and
identify one of the target text strings of the one or more overlapping regions to be a match for the template text string based, at least in part, on a nearest neighbors analysis comparing the target text strings of those of the identified regions that overlap the boundary defined by the template spatial coordinates to the template text string.

2. The computing system of claim 1, wherein the computer-readable instructions are further configured to instruct the one or more processors to:
preprocess an image of the target document to generate target image data of the target image; and
store the target image data on the one or more data storage devices.

3. The computing system of claim 1, wherein the computer-readable instructions are further configured to instruct the one or more processors to identify the template spatial coordinates from template image data corresponding to the template image.

4. The computing system of claim 1, wherein the computer-readable instructions are further configured to rank the overlapping regions based, at least in part, on distances of their target spatial coordinates from the template spatial coordinates.

5. The computing system of claim 4, wherein the computer-readable instructions are configured to traverse the target text strings using the nearest neighbors analysis in an order defined by the rank of the corresponding overlapping regions.

6. The computing system of claim 1, wherein the computer-readable instructions are further configured to:
adjust the template spatial coordinates to increase an area defined by the template spatial coordinates responsive to a determination that there are no overlapping regions in the target image; and
again identify the target spatial coordinates defining the boundaries around the one or more overlapping regions based on the adjusted template spatial coordinates.

7. The computing system of claim 1, wherein the boundary around the template text string defines a polygon.

8. The computing system of claim 1, wherein the computing system comprises an image capture device configured to provide image data to the one or more data storage devices to store the image data as one or more of template image data corresponding to the template image or target image data corresponding to the target image.

9. The computing system of claim 1, wherein the computing system comprises a network interface configured to provide image data to the one or more data storage devices to store the image data as one or more of template image data corresponding to the template image or target image data corresponding to the target image.

10. A method of extracting text strings from a target image, the method comprising:
identifying template spatial coordinates from template image data corresponding to a template image of a template document, the template spatial coordinates defining a boundary around a template text string in the template image;
identifying, in a target image of a target document corresponding to the template document, target spatial coordinates defining boundaries around one or more identified regions including target text strings;
identifying overlapping regions of the one or more identified regions that overlap the boundary defined by the template spatial coordinates; and
identifying one of the target text strings to be a match for the template text string based, at least in part, on a nearest neighbors analysis comparing the template text string to the target text strings corresponding to the overlapping regions.

11. The method of claim 10, further comprising receiving image data from a network interface and storing the image data as the template image data.

12. The method of claim 10, further comprising receiving image data from a network interface and storing the image data as target image data corresponding to the target image.

13. The method of claim 10, further comprising receiving image data from an image capture device and storing the image data as the template image data.

14. The method of claim 10, further comprising receiving image data from an image capture device and storing the image data as target image data corresponding to the target image.

15. The method of claim 10, further comprising preprocessing the target image to improve a quality of the target image.

16. The method of claim 10, further comprising:
ranking the overlapping regions based, at least in part, on distances of their target spatial coordinates from the template spatial coordinates; and
traversing the target text strings using the nearest neighbors analysis in an order of the ranking of the overlapping regions.

17. The method of claim 10, further comprising adjusting the template spatial coordinates to increase an area defined by the boundary around the template text string responsive to a determination that no overlapping regions are identified.

18. The method of claim 17, further comprising repeating the identifying the overlapping regions of the one or more identified regions that overlap the boundary defined by the adjusted template spatial coordinates.

19. One or more non-transitory computer-readable media including computer-readable instructions stored thereon, the computer-readable instructions configured to instruct one or more processors to:
identify, in a target image of a target document, target spatial coordinates defining boundaries around one or more identified regions including target text strings;
identify those of the identified regions that overlap a boundary defined by template spatial coordinates of a template region including a template text string within a template image of a template document corresponding to the target document;
adjust the template spatial coordinates to increase an area of the template region responsive to a determination that one or more relevant overlapping regions are yet to be identified;
rank overlapping regions based, at least in part, on distances of their target spatial coordinates from the template spatial coordinates; and
identify one of the target text strings to be a match for the template text string based, at least in part, on a nearest neighbors analysis comparing the template text string to the target text strings corresponding to the overlapping regions.

20. The more non-transitory computer-readable media of claim 19, wherein the target document is a fillable form.
